(19) United States
(12) Patent Application Publication
(10) Pub. No.: US 2010/0271216 A1
(43) Pub. Date: Oct. 28, 2010

(54) OUTDOOR RAIN FOG DETECTOR SWITCH GEAR

(75) Inventor: Yi-Qun CHEN, Taichung City (TW)

Correspondence Address: EGBERT LAW OFFICES, 412 MAIN STREET, 7TH FLOOR, HOUSTON, TX, 77002, US

(73) Assignee: SAFETY TRAFFIC EQUIPMENT Co., Ltd., Taichung City (TW)

(21) Appl. No.: 12/697,662

(22) Filed: Feb. 1, 2010

(30) Foreign Application Priority Data
Apr. 24, 2009 (TW) 098206888

(51) Int. Cl. G08B 21/00

(52) U.S. Cl. 340/602

(57) ABSTRACT

An outdoor rain fog detector switch gear has a hollow housing with roof and wall; an assembly locating portion to assemble and locate the rain fog detector switch gear onto the object; a retaining space; a punch hole to connect the retaining space with ambient environment; a circuit board connected with a power supply line that protrudes out of the housing to connect electrically with the control circuit of the intended electrical device. The circuit board is also connected with a signal line to output a switching control signal or digital detection signal. A moisture probe senses and detects the moisture in ambient environment. The circuit board permits to turn on/off its automatic switching control function depending on the sensing state of the moisture probe. A protective film is covered externally onto the circuit board for waterproofing. The moisture probe is exposed outside of the protective film.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to an outdoor detector switch gear, and more particularly to an innovative one which is specifically used to detect outdoor rain fog by controlling automatically the on/off state of outdoor electric switches.

2. Description of Related Art Including Information Disclosed Under 37 CFR 1.97 and 37 CFR 1.98.

As for some outdoor electrical devices, such as LED indicators, LED warning lights, LED advertising lights and LED landscape lights as well as common street lights, the climatic conditions are decisive influential factors to their startup and operation. For instance, an LED indicator is generally closed in the daytime and highlighted in the nighttime. In such a case, it is commonly controlled by means of manual and auto modes, of which the former one has the shortcomings such as: human error leading to delay or omission of turning-on/off the switch, and the latter one has the following shortcomings despite of its ability of accurate switching.

An LED indicator is generally employed to provide highlighting indication or alarming to the people under dark or obscure climate conditions. For these purposes, they have to be highlighted under foggy and rainy weather conditions in addition to during the nighttime. Yet, if a timer structure is introduced to existing an LED indicator with auto mode, such a device cannot be started automatically under aforementioned foggy and rainy conditions. If a photosensitive auto mode is introduced, such a device cannot be started automatically under the aforementioned climatic conditions once the degree of darkness fails to reach the embedded threshold of startup.

In view of the existing problems against the control mechanism of said LED indicator, a great concern shall be raised to develop a mechanism that can start automatically the street lights under foggy and rainy conditions. Also, other outdoor electrical devices, such as street lights and sprinklers, also encounter such issues and requirements.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The enhanced efficacy of the present invention is as follows:

Based on the unique configuration of the present invention wherein the “outdoor rain fog detector switch gear” comprises of a housing, an assembly locating portion, a retaining space, a circuit board, a moisture probe and a protective film, it can be widely applied to switching control of outdoor electrical devices such as LED indicators, lights and sprinklers, helping to control accurately the switching state of outdoor electrical devices in foggy and rainy conditions with improved applicability.

The improvements brought about by this invention are as follow:

Based on the structural configuration wherein said punch hole is opened downwards at the bottom of the housing, this makes it possible to prevent efficiently entry of rainwater, dirt, strong wind and bugs into the retaining space against the circuit board and realize optimum sensing effect for the moisture.

With the arrangement of said protective film, the circuit board can be sealed for waterproofing and protection of the circuit board with an extended service life.

Based on the structural configuration wherein said circuit board is equipped with a photoresistor, the circuit board can be turned on/off according to the information of both the moisture probe (i.e. moisture control mode) and the photoresistor, thus realizing automatic switching control depending on the brightness in the ambient environment (light control mode).

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the present invention.

FIG. 2 shows a cross-sectional perspective view of the preferred embodiment of the present invention.

FIG. 3 shows a schematic view of the preferred embodiment of the present invention.

FIG. 4 shows a schematic view of the present invention wherein the rain fog detector switch gear is applied to the street light.

FIG. 5 shows a schematic view of the present invention wherein the rain fog detector switch gear is equipped with a photoresistor.

### DETAILED DESCRIPTION OF THE INVENTION

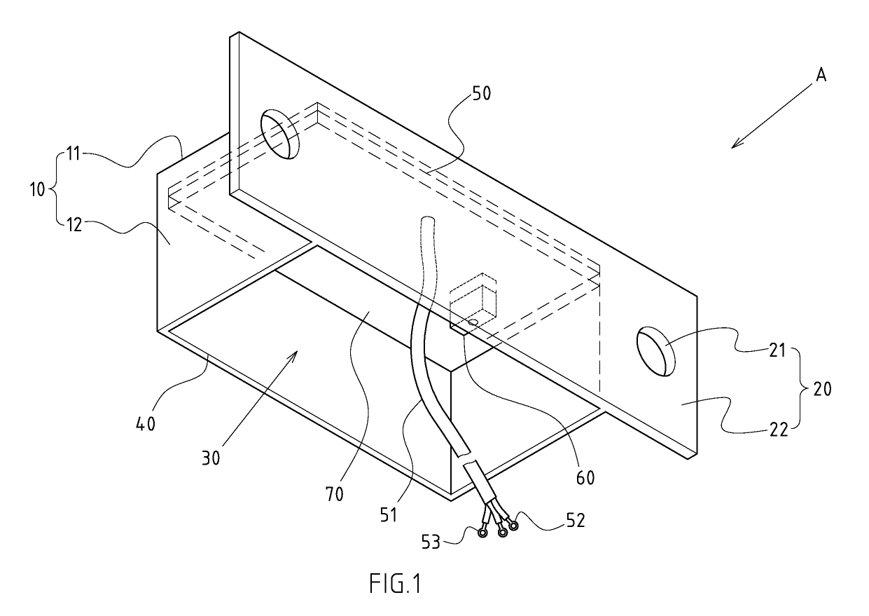

FIGS. 1-3 depict preferred embodiments of an outdoor rain fog detector switch gear of the present invention, which are provided for only explanatory objective for patent claims. Said rain fog detector switch gear A is mounted onto an object in outdoor environment, and used to detect the foggy or rainy state in the ambient environment and execute automatic switching of an intended electrical device. Said electrical devices include LED indicators, street lights, advertising lights, warming lights and sprinkler Said objects includes poles, walls, trunks and racks. The rain fog detector switch gear A includes a housing 10, which is a hollow housing that defines at least a roof 11 and a wall 12. The housing 10 of the preferred embodiment is configured into a rectangular housing;

An assembly locating portion 20 is arranged onto at least one position of the housing 10, and used to assemble and locate the rain fog detector switch gear A onto the object. In the preferred embodiment, the assembly locating portion 20 includes two ear plates 22 with a through-hole 21. These two ear plates 22 are protruded from two sides of the wall 12 of the housing 10. Said through-hole 21 is used for threading and positioning of existing bolts and nails.

A retaining space 30 is formed in the housing 10.

At least one punch hole 40 is opened onto at least one lower position of the housing 10, and used to connect the retaining space 30 with ambient environment. The punch hole 40 of the preferred embodiment is opened downwards at the bottom of the wall 12 of the housing 10.

A circuit board 50 is arranged within the retaining space 30, and connected with a power supply line 51. The power supply line 51 is provided with an external connection end 52, which is protruded out of the housing 10 and electrically connected with the control circuit of the intended electrical device. The circuit board 50 of the preferred embodiment is adhered at internal side of the roof 11 of the housing 10, and the external connection end 52 of the power supply line 51 is protruded out of the housing 10 through the punch hole 40.

A signal line 53 has one end connected with the circuit board 50, and the other end protruded out of the housing 10. The signal line 53 is used to output a switching control signal or digital detection signal.

A moisture probe 60 is mounted onto the circuit board 50 to sense and detect the moisture in ambient environment. The moisture probe 60 is electrically connected with the circuit board 50, so that the circuit board 50 permits to turn on/off its automatic switching control function depending on the sensing state of the moisture probe 60.

A protective film 70 is covered externally onto the circuit board 50 for waterproofing. The moisture probe 60 is exposed outside of the protective film 70, and said power supply line 51 and signal line 53 are threaded out of the protective film 70. Moreover, said protective film 70 is coated with various waterproofing agents.

Based on above-specified structural configuration, the present invention is operated as follows:

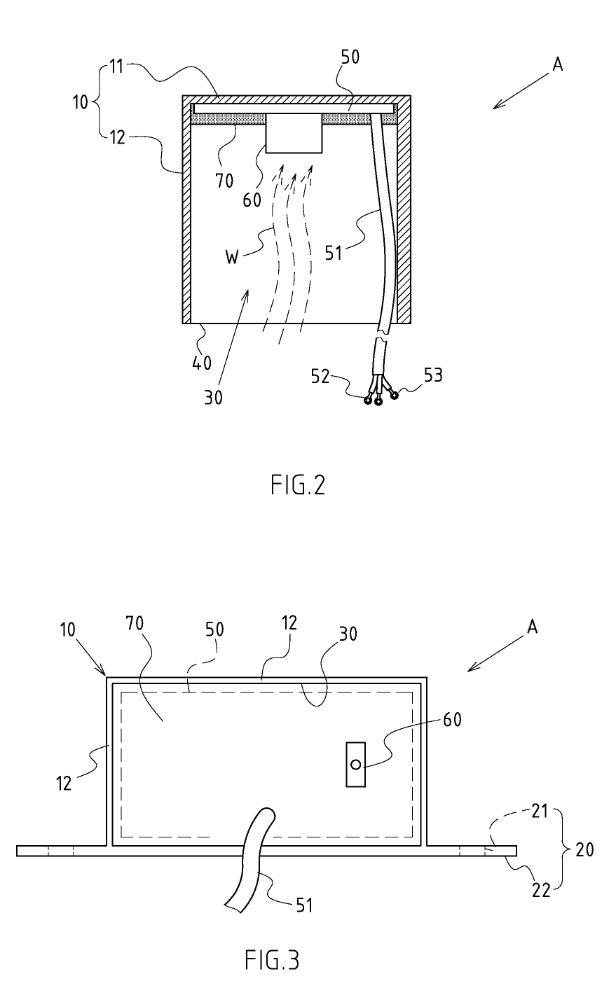

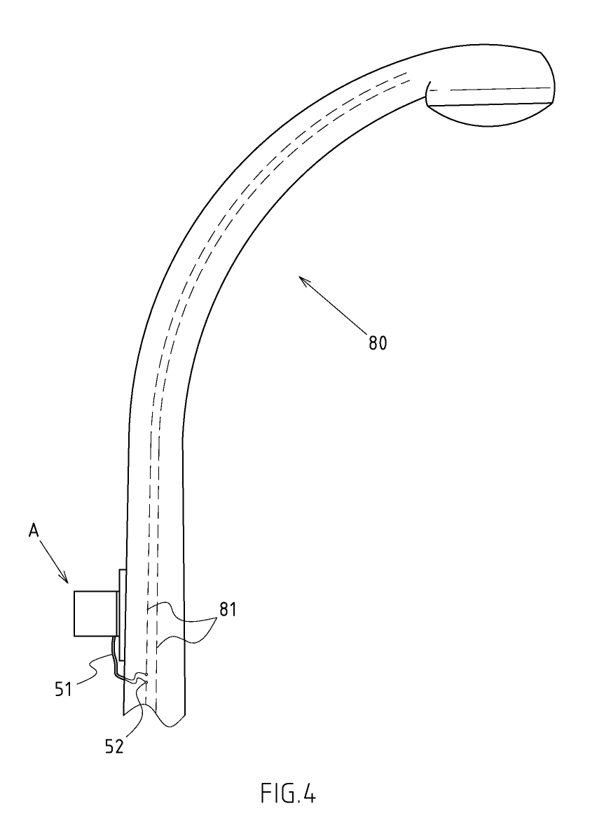

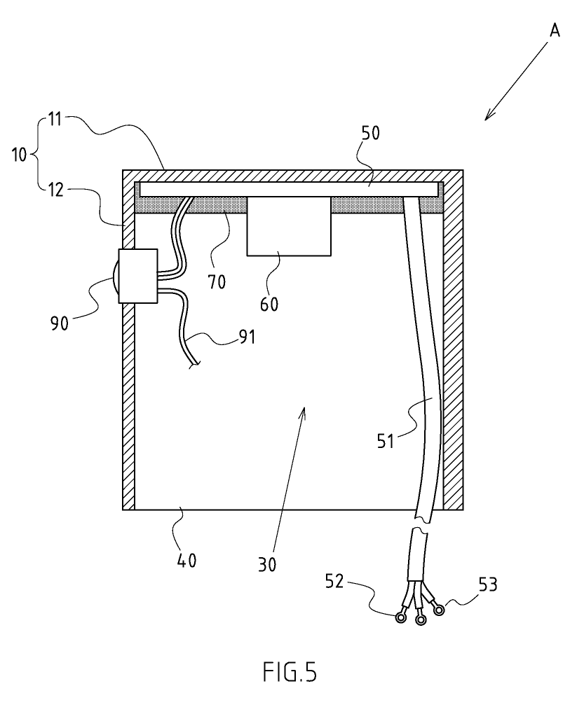

Referring to FIG. 4, an application view of the present invention wherein said rain fog detector switch gear A is applied to a street light 80, wherein the rain fog detector switch gear A is mounted at proper location on the post of the street light 80, and the external connection end 52 of the power supply line 51 is electrically connected with the control circuit 81 of the street light 80. Referring also to FIG. 2 for the operation of the rain fog detector switch gear A, the moisture W generated in foggy or rainy conditions will enter into the retaining space 30 through the punch hole 40 at the bottom of the housing 10. In such a case, the moisture probe 60 can sense and detect the moisture. Once the moisture reaches the preset threshold, the sensing signal can output to the control circuit of the street light 80 to turn on the control circuit, and then highlight the street light 80 automatically through the power supply line 51 and signal line 53 connected with the circuit board 50. The circuit can be turned on/off automatically through the circuit planning of the circuit board 50. Certainly, said rain fog detector switch gear A of the present invention is more suitable for LED indicators (including LED marks, LED advertising lights and LED landscape lights), due to its stronger penetrating power and brightness compared to common lights. So the rain fog detector switch gear A can provide better indication, warning and lighting effects in rainy or foggy weather conditions.

Referring also to FIG. 5, the circuit board 50 is equipped with a photoresistor 90, which is used to sense and detect the optical brightness of ambient environment, so that the circuit board 50 permits to turn on/off its automatic switching control function depending on the sensing state of the photoresistor 90. Furthermore, the photoresistor 90 is connected with a second signal line 91, which protrudes out of the housing 10 to output the sensing signal of the photoresistor 90. With this configuration, the circuit board 50 can be turned on/off according to the information of both moisture probe 60 (i.e. moisture control mode) and photoresistor 90, thus realizing automatic switching control depending on the brightness in the ambient environment (light control mode).

Additionally, said rain fog detector switch gear A of the present invention can be applied to a street light 80 and LED indicator, but also to other outdoor lights such as advertising and warning lights for automatic switching control. Also, said rain fog detector switch gear A can be applied to a sprinkler as it is used depending much on the ambient humidity. Thus, said rain fog detector switch gear A of the present invention can be used to control the on-off state of the sprinkler for saving the irrigation water.

1. An outdoor rain fog detector switch gear, wherein said rain fog detector switch gear is mounted onto an object in outdoor environment, and used to detect the foggy or rainy state in the ambient environment and execute automatic switch of an intended electrical device; the rain fog detector switch gear comprises:
a housing, said housing being hollow and defining at least a roof and a wall;
a retaining space, formed in the housing;
at least a punch hole, opened onto at least a lower position of the housing, and used to connect the retaining space with ambient environment;
a circuit board, arranged within the retaining space, and connected with a power supply line; the power supply line is provided with an external connection end, which is protruded out of the housing and electrically connected with the control circuit of the intended electrical device;
a signal line having one end connected with the circuit board, and the other end protruded out of the housing; the signal line is used to output a switching control signal or digital detection signal;
a moisture probe, mounted onto the circuit board to sense and detect the moisture in ambient environment; said moisture probe is electrically connected with the circuit board, so that the circuit board permits to turn on/off its automatic switching control function depending on a sensing state of the moisture probe;
a protective film, covered externally onto the circuit board for waterproofing; the moisture probe is exposed outside of the protective film, and said power supply line and signal line are threaded out of the protective film.

2. The structure defined in claim 1, wherein an assembly locating portion is arranged in at least one position on the housing, and used to assemble and locate the rain fog detector switch gear onto the object.

3. The structure defined in claim 2, wherein the assembly locating portion includes two ear plates with a through-hole; these two ear plates are protruded from two sides of the wall of the housing; said through-hole is used for threading and positioning of existing bolts and nails.

4. The structure defined in claim 1, wherein said punch hole is opened onto the bottom of the wall of the housing.

5. The structure defined in claim 1, wherein the circuit board is adhered at internal side of the roof of the housing, and the external connection end of the power supply line is protruded out of the housing through the punch hole.

6. The structure defined in claim 1, wherein said circuit board is equipped with a photoresistor, which is used to sense and detect the optical brightness of ambient environment, so that the circuit board permits to turn on/off its automatic switching control function depending on the sensing state of the photoresistor; furthermore, the photoresistor is connected with a second signal line, which protrudes out of the housing to output the sensing signal of the photoresistor.

7. The structure defined in claim 1, wherein the intended electrical device is either an LED indicator, street light, advertising light, warning light or sprinkler.
